(19) United States
(12) Patent Application Publication
(10) Pub. No.: US 2023/0220717 A1
(43) Pub. Date: Jul. 13, 2023

(54) CLOSURE LATCH ASSEMBLY WITH INTEGRATED DOOR PRESENTER

(71) Applicant: MAGNA CLOSURES INC., Newmarket (CA)

(72) Inventor: Roman CETNAR, Newmarket (CA)

(21) Appl. No.: 18/094,404

(22) Filed: Jan. 9, 2023

Related U.S. Application Data
(60) Provisional application No. 63/298,994, filed on Jan. 12, 2022.

(51) Int. Cl. E05F 15/63; E05B 81/06; E05B 81/16; E05F 15/70

(52) U.S. Cl. CPC E05F 15/63; E05B 81/06; E05B 81/16; E05F 15/70; E05B 81/56

(57) ABSTRACT

A power latch and presenter assembly for latching and releasing a closure panel and for moving the closure panel from a closed position to a presented position includes a ratchet moveable between a striker capture position and a striker release position. A pawl is configured for movement between a ratchet holding position, whereat the pawl maintains the ratchet in the striker capture position and a ratchet releasing position. A power release actuator is configured to move the pawl from the ratchet holding position to the ratchet releasing position and to move a presenter arm between a non-deployed position, whereat the presenter arm is spaced from the striker, to a deployed position, whereat the presenter arm engages the striker to move the closure panel from the closed position to the presented position. A power presenter actuator is configured to move the presenter arm from the non-deployed position to the deployed position.

### CROSS-REFERENCE TO RELATED APPLICATION

This application claims the benefit of U.S. Provisional Application Ser. No. 63/298,994, filed Jan. 12, 2022, which is incorporated herein by way of reference in its entirety.

### FIELD

The present disclosure relates generally to automotive door latches, and more particularly, to a power door latch assembly equipped with a power release and power present mechanism.

### BACKGROUND

This section provides background information related to automotive door latches and is not necessarily prior art to the concepts associated with the present disclosure.

A vehicle closure panel, such as a side door for a vehicle passenger compartment, is typically hinged to swing between open and closed positions and includes a latch assembly mounted to the door. The latch assembly functions in a well-known manner to latch the door when it is closed and unlatch and release the door to permit subsequent movement of the door to its open position. As is also well known, the latch assembly is configured to include a latch mechanism for latching the door and a release mechanism for unlatching the door. The release mechanism can be power-operated to unlatch the door.

Upon being unlatched, it also known to actuate a door presenter unit located remotely from the latch assembly, where space is available inside the door or inside a bottom sill region of the vehicle body to fix the presenter unit, commonly along a bottom or base of the door, so as to move the door to a “so called” presented position. When in the presented position, a shut face of the door is moved sufficiently outwardly from the door sill of the vehicle body such that a person is more easily able to grasp a side edge of the door, if desired, to move the door to a fully open position. Known door presenters, although useful to move the door to the presented position, are typically bulky and occupy a significant amount of space, either inside the door or inside the vehicle body, depending on the arrangement of the presenter unit. Known door presenters typically require a sizable motor in order to drive a linear device, such as a leadscrew or other type of linear actuator, outwardly between the door and the vehicle body move a telescoping member sufficiently to move the door to the presented position. Further yet, in regions where ice is common, the motor must be able to overcome ice buildup between the door and the vehicle body, or within components of the latch assembly in order to break the ice to allow the door to be moved, as desired. As such, the incorporation of known presenters into a door/vehicle body requires a good amount of space, and often places limits on the design of the door or vehicle body.

Thus, there remains a need to develop alternative arrangements for door presenters used to move vehicular doors to a presented position, with consideration being given to overcoming the force of potential ice buildup; which optimizes the ability to move a door to a presented position under the power of a powered motor without having to provide the powered motor and other components of the presenter having an overly large size limiting the flexibility of design of the door/vehicle body; which reduces weight of the motor vehicle, and which is economical in manufacture and assembly.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that overcomes at least those drawbacks discussed above associated with known power latch assemblies.

It is another object of the present disclosure to provide a power presenter assembly for motor vehicle closure applications that overcomes at least those drawbacks discussed above associated with known power presenter assemblies.

It is another object of the present disclosure to provide a power latch and presenter assembly for motor vehicle closure applications that overcomes at least those drawbacks discussed above associated with known power latch and power presenter assemblies.

It is another object of the present disclosure to provide a power latch assembly for motor vehicle closure applications that has a motor that is optimized and minimized in size, while being optimized in output force.

It is another object of the present disclosure to provide a power presenter assembly for motor vehicle closure applications that has a motor that is optimized and minimized in size and optimized in output force.

In accordance with the above objects, one aspect of the disclosure provides a power latch and presenter assembly for latching and releasing a closure panel and for moving the closure panel from a closed position to a presented position relative to a motor vehicle body. The power latch and presenter assembly includes a ratchet configured for movement between a striker capture position, whereat the ratchet captures a striker against release from the ratchet, and a striker release position, whereat the ratchet releases the striker for removal from the ratchet, and being biased toward the striker release position. The power latch and presenter assembly includes a pawl configured for movement between a ratchet holding position, whereat the pawl maintains the ratchet in the striker capture position, and a ratchet releasing position, whereat the pawl releases the ratchet for movement of the ratchet to the striker release position. The power latch and presenter assembly includes a power release actuator configured to move the pawl from the ratchet holding position to the ratchet releasing position and a presenter arm configured for movement between a non-deployed position, whereat the presenter arm is configured to be spaced from the striker, and a deployed position, whereat the presenter arm is configured for engagement with the striker to move the closure panel from the closed position to the presented position. The power latch and presenter assembly includes a power presenter actuator configured to move the presenter arm from the non-deployed position to the deployed position.

In accordance with another aspect of the disclosure, the presenter arm is configured for pivotal movement about a presenter arm axis for movement between the non-deployed position and the deployed position.

In accordance with another aspect of the disclosure, the power latch and presenter assembly includes a multistage reduction mechanism operably connecting an output of the power presenter actuator to the presenter arm.

In accordance with another aspect of the disclosure, the multistage reduction mechanism applies a torque force on the presenter arm to increase the force with which the presenter arm is able to apply to the striker.

In accordance with another aspect of the disclosure, the multistage reduction mechanism includes a plurality of gear reductions to further enhance the force with which the presenter arm is able to apply to the striker and to minimize the size of the power presenter actuator needed to move the closure panel to the presented position.

In accordance with another aspect of the disclosure, the plurality of gear reductions includes a first gear reduction configured in meshed engagement with a second gear reduction, and a third gear reduction configured in meshed engagement with the second gear reduction.

In accordance with another aspect of the disclosure, the presenter arm has presenter arm gear teeth forming a portion of the multistage reduction mechanism.

In accordance with another aspect of the disclosure, the first gear reduction is provided by an output gear of the power presenter actuator configured in meshed engagement with a first driven gear, the second gear reduction is provided by a first pinion gear, fixed to the first driven gear for conjoint rotation therewith about a common axis, configured in meshed engagement with a second driven gear, and the third gear reduction is provided by the presenter arm gear teeth configured in meshed engagement with a second pinion gear fixed to the second driven gear for conjoint rotation therewith about a common axis.

In accordance with another aspect of the disclosure, the power release actuator is configured in operable communication with the power presenter actuator via a controller.

In accordance with another aspect of the disclosure, the power presenter actuator is configured to be actuated immediately after, and in response to the actuation the power release actuator.

In accordance with another aspect of the disclosure, the power release actuator is configured to move the pawl from the ratchet holding position to the ratchet releasing position prior to the power presenter actuator moving the presenter arm from the non-deployed position to the deployed position.

In accordance with another aspect of the disclosure, the controller commands the power presenter actuator to move the presenter arm from the deployed position back to the non-deployed position within a predetermined time after being moved to the deployed position.

In accordance with another aspect of the disclosure, the controller commands the power presenter actuator to move the presenter arm from the deployed position back to the non-deployed position immediately upon moving the closure panel to the presented position.

In accordance with another aspect of the disclosure, a method of releasing a power latch assembly and moving a closure panel of a motor vehicle from a closed position to a presented position is provided. The method includes, detecting a command to power release the power latch assembly; actuating a power release actuator to move a pawl from a ratchet holding position to a ratchet releasing position; actuating a power presenter actuator to move a presenter arm from a non-deployed position to a deployed position, during which the presenter arm engages a striker and moves the closure panel from the closed position to the presented position.

In accordance with another aspect of the disclosure, the method further includes moving the presenter arm from the non-deployed position to the deployed position under a force applied by a multistage reduction mechanism operably coupling the power presenter actuator to the presenter arm.

In accordance with another aspect of the disclosure, the method can further include providing the multistage reduction mechanism having a plurality of gear reductions.

In accordance with another aspect of the disclosure, the method can further include providing presenter arm having a plurality of presenter arm gear teeth forming a portion of the plurality of gear reductions.

In accordance with another aspect of the disclosure, the method can further include arranging the power release actuator in operable communication with the power presenter actuator via a controller and configuring the controller to actuate the power release actuator and the power presenter actuator in precisely timed relation with one another.

In accordance with another aspect of the disclosure, the method can further include configuring the controller to actuate the power release actuator in advance of actuating the power presenter actuator.

In accordance with another aspect of the disclosure, a presenter assembly for moving a closure panel from a closed position to a presented position relative to a motor vehicle body is provided. The presenter assembly includes a presenter arm configured for movement between a non-deployed position, whereat the presenter arm is configured to be spaced from a striker, and a deployed position, whereat the presenter arm is moved into engagement with the striker to move the closure panel from the closed position to the presented position; and a power presenter actuator configured to move the presenter arm from the non-deployed position to the deployed position.

In accordance with another aspect of the disclosure, a presenter assembly for moving a closure panel from a closed position to a presented position relative to a motor vehicle body, having a presenter arm configured for movement between a non-deployed position and a deployed position to move the closure panel from the closed position to the presented position, and a power presenter actuator configured to move said presenter arm from the non-deployed position to the deployed position, wherein the presenter arm is configured to move along a non-linear path during movement between the non-deployed position and the deployed position.

In accordance with another aspect of the disclosure, a presenter assembly for moving a closure panel from a closed position to a presented position relative to a motor vehicle body, having a presenter arm configured for movement between a non-deployed position and a deployed position to move the closure panel from the closed position to the presented position, and a power presenter actuator configured to move said presenter arm between the non-deployed position to the deployed position, wherein the presenter arm is configured to contact the striker during moving of the closure panel.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle having a side door equipped with a power latch assembly with presenter assembly embodying the teachings of the present disclosure;

FIG. 2 is a front side view of a power latch assembly embodying the teachings of the present disclosure shown schematically in operable communication with various components of the side door, with some components removed for clarity purposes only;

FIG. 2A is a front side perspective view of the power latch assembly of FIG. 2;

FIG. 2B is a rear side perspective view of the power latch assembly of FIG. 2;

FIG. 2C is a side view of the power latch assembly of FIG. 2;

FIG. 3 is a front side view of the power latch assembly shown in a closed position;

FIG. 3A is a rear side view of the power latch assembly of FIG. 3;

FIG. 4 is a front side view of the power latch assembly shown with a latch mechanism in a released position and a presenter assembly in a non-deployed position;

FIG. 4A is a rear side view of the power latch assembly of FIG. 4;

FIG. 5 is a front side view of the power latch assembly shown with the latch mechanism in a released position and the presenter assembly in a deployed position;

FIG. 5A is a rear side view of the power latch assembly of FIG. 5;

FIG. 6 is a front side view of the power latch assembly shown with the latch mechanism in a released position and the presenter assembly in returned to the non-deployed position;

FIG. 6A is a rear side view of the power latch assembly of FIG. 6;

FIG. 7 is a rear side view of a standalone presenter assembly in accordance with another aspect of the disclosure shown in a non-deployed position;

FIG. 7A is a front side view of the standalone presenter assembly of FIG. 7;

FIG. 7B is a front side view of the presenter arm of assembly of FIG. 7 illustrating a projected non-linear path of travel of the arm, in accordance with an illustrative example;

FIG. 7C is a front side view of the presenter arm of assembly of FIG. 7 illustrating the presenter arm following a non-linear path of travel, in accordance with an illustrative example; and

FIG. 8 is a method of releasing a power latch assembly and moving a closure panel of a motor vehicle from a closed position to a presented position.

Corresponding reference numerals are used throughout all of the drawings to indicate corresponding parts.

### DETAILED DESCRIPTION OF EXAMPLE EMBODIMENTS

One or more example embodiments of a latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

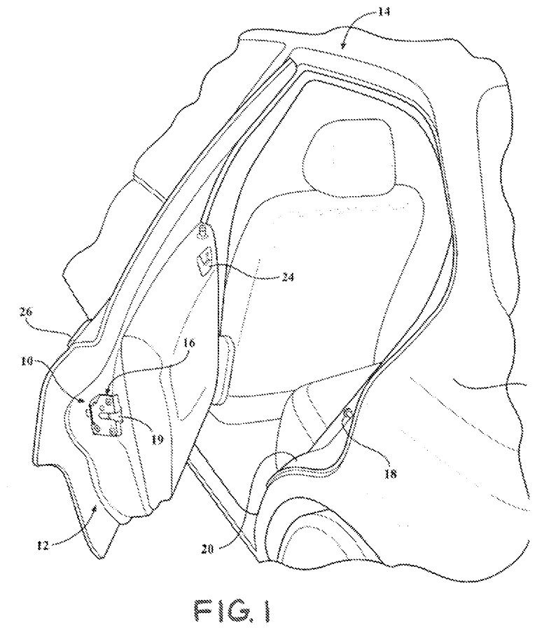

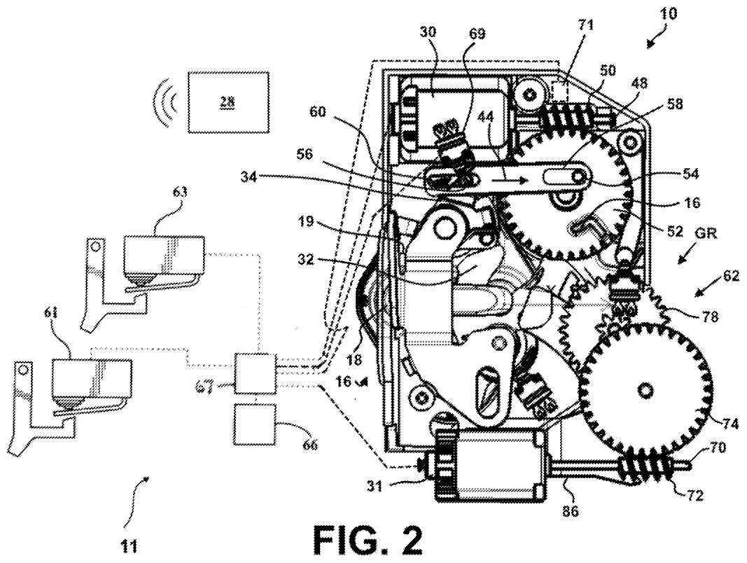

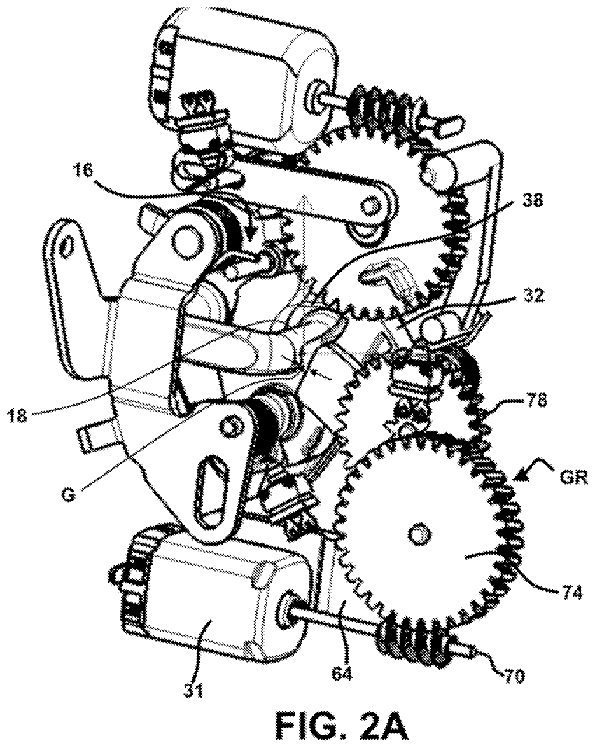

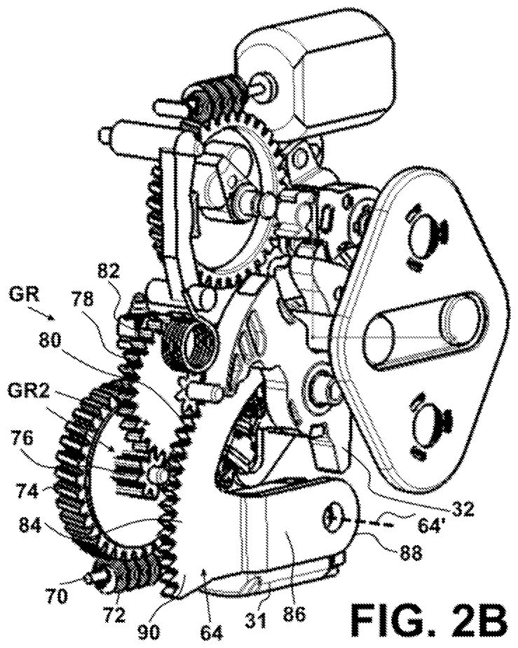

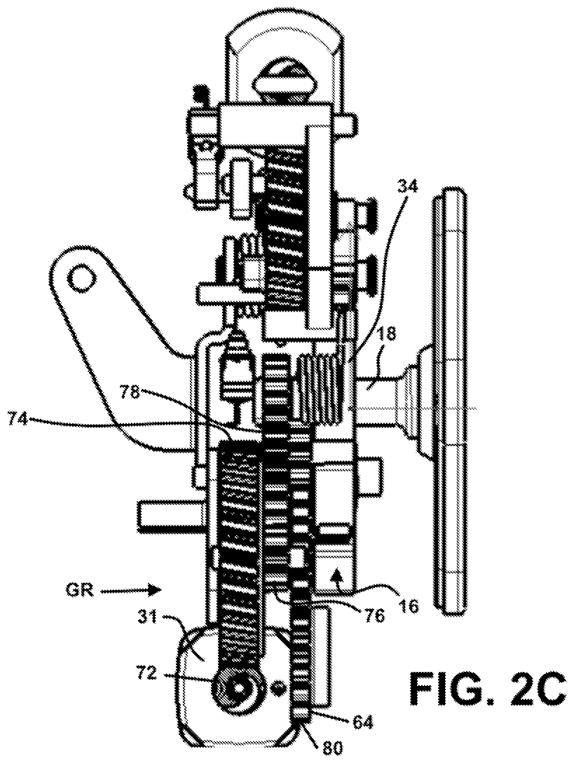

Referring initially to FIG. 1, a non-limiting example of a power latch and presenter assembly is shown, referred to hereafter simply as latch assembly 10, installed in a closure panel, such as, by way of example and without limitation, a door, shown as a passenger side swing door 12 of a motor vehicle 14. Latch assembly 10 includes a latch mechanism 16 configured to releasably latch and hold a striker 18 mounted to a sill portion 20 of a vehicle body 22 when door 12 is closed, thereby releasably maintaining the door 12 in a closed position. Latch assembly 10 can be selectively actuated, such as via an inside door handle 24, an outside door handle 26, and a key fob 28 (FIG. 2), by way of example and without limitation. As will be detailed, latch assembly 10 is configured to be power-operated via selective actuation of a power release actuator, such as can be provided by an electric motor 30, and door 12 is configured to be moved from the closed position to a presented position (a term well understood by one possessing ordinary skill in the art of modern powered vehicle doors) via selective actuation of a power presenter actuator, such as can be provided by an electric motor 31. For reasons discussed hereafter, power release actuator 30 and power presenter actuator 31 are able to be minimized in size, weight and optimized in power output, thereby enhancing the flexibility of design of the door 12 and vehicle body 22, particularly in the sill portion 20, while also reducing the cost associated manufacture and assembly thereof. Further yet, as discussed in further detail below, the power presenter actuator 31 is assured of having sufficient power to move door 12 from the closed position to the presented position, even if friction forces within latch mechanism 16 and/or between the door 12 and the vehicle body 22 are suddenly increased, such as may result in a crash condition of motor vehicle 14 or a buildup of snow and/or ice between door 12 and vehicle body 22 or about latch mechanism 16, thereby allowing door 12 to be moved from the closed position to the presented position, when desired.

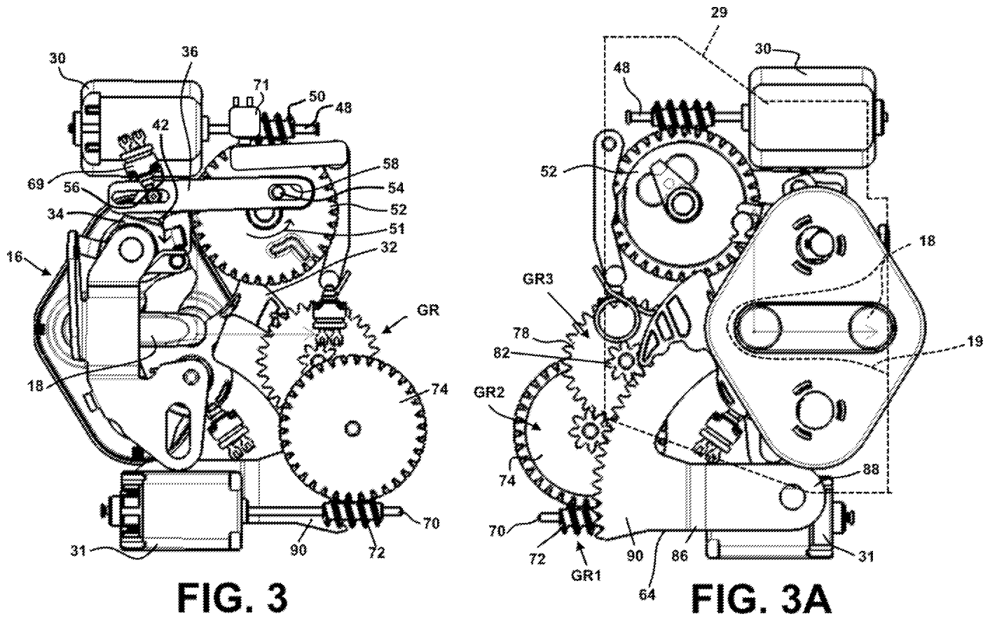

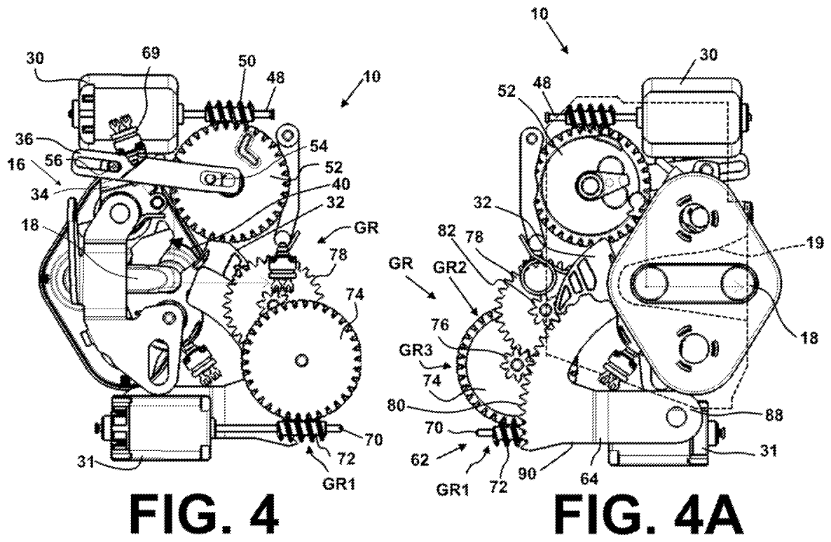

Referring to FIG. 2, shown is a non-limiting embodiment of a latch system 11 including latch assembly 10 and latch mechanism 16 contained in a housing, shown in part via a latch frame plate 29, with latch assembly 10 also shown in various views, including front and rear perspective views and a side view in FIGS. 2A-2C, respectively, with some components removed for clarity purposes only. Latch mechanism 16 includes a ratchet 32, a pawl, also referred to as pawl lever 34, and a pawl release link, also referred to as release link 36. Ratchet 32 is movable between a striker capture position, whereat ratchet 32 retains striker 18 with a striker slot 38 (only labeled in FIG. 2A to avoid cluttering the FIGS.) of ratchet 32 to releasably retain door 12 in the closed position, and a striker release position, whereat ratchet 32 permits release of striker 18 from striker slot 38 and from a fishmouth 19 provided by latch housing 29 of latch assembly 10 to allow movement of door 12 to the presented position and the open position. A ratchet biasing member 40 (FIG. 4), such as a spring, is provided to normally bias ratchet 32 toward its striker release position. Pawl 34 is movable between a ratchet holding position, whereat pawl 34 holds ratchet 32 in its striker capture position, and a ratchet releasing position, whereat pawl 34 permits ratchet 32 to move to its striker release position under the bias of ratchet biasing member 40. A pawl biasing member 42 (FIG. 3), such as a suitable spring, is provided to normally bias pawl 34 toward its ratchet holding position. Striker 18 is formed as a striker loop having a pair of opposite extending side striker members 18a which are interconnected together with a striker cross member 18b

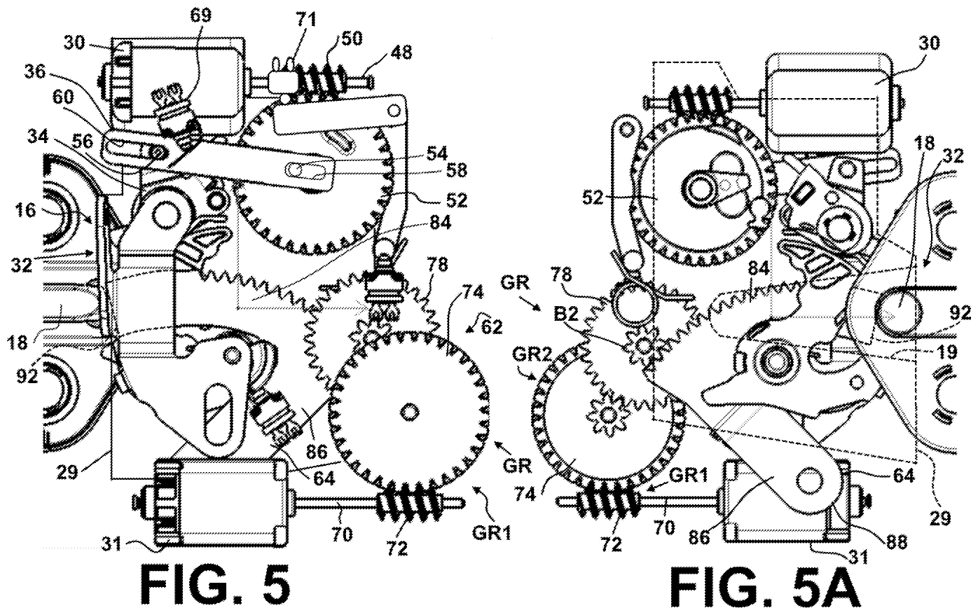

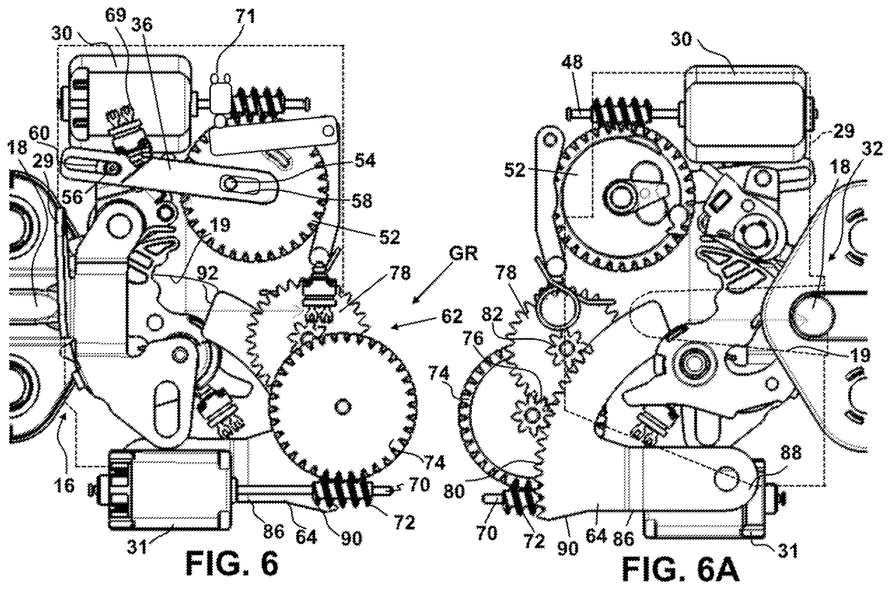

Pawl release link 36 is operatively (directly or indirectly via another component, such as an intermediate or secondary pawl release lever, and shown as directly, by way of example and without limitation) coupled, also referred to as connected, to pawl 34 and is movable between a deployed position, also referred to as pawl release position (FIGS. 4-6A), whereat pawl release link 36 moves pawl 34 against the bias of pawl biasing member 42 to its ratchet releasing position, and a non-deployed position, also referred to as home position (FIGS. 2-3A), whereat pawl release link 36 permits pawl 32 to remain in its ratchet holding position under the bias of pawl biasing member 42. A release link biasing member 44 (FIG. 2), such as a suitable spring, can be provided to normally bias pawl release link 36 to its home position.

Pawl release link 36 can be moved to its pawl release position via selective (intentional) actuation of power release actuator 30. Power release actuator 30 has an output, shown as being provided by an output member, also referred to as output shaft 48, which is operably connected or coupled to pawl 34 via a release link 36. Output shaft 48, when driven by power release actuator 30, is configured to move pawl release link 36 to its pawl release position, whereat pawl 34 is moved to its ratchet releasing position.

Release link 36 is shown directly coupling a power release gear 52 to pawl 34, and in a non-limiting embodiment, is shown being coupled to a drive pin 54 fixed to power release gear 52 and to a driven pin 56 fixed to pawl 34. Drive pin 54 and driven pin 56, by way of example and without limitation, are shown received within elongate slots 58, 60, respectively, of release link 36 for selective lost-motion therein. Lost-motion travel of drive and driven pins 54, 56 in respective slots 58, 60 allows for inertia buildup, which in turn promotes and allows the use of a reduced size motor 30 to effect desired actuation of latch mechanism 16.

When desired to move pawl 34 from the ratchet holding positon (FIGS. 2-3A) to the ratchet releasing position (FIGS. 4-6A), such as when a person approaches motor vehicle 14 with electronic key fob 28 (FIG. 2) or actuates the outside door handle 26, for example, sensing a present command from the key fob 28 and/or that outside door handle 26 has been actuated, e.g. via electronic communication between an electronic switch 61 (FIG. 2, wherein inside door handle 24 also is actuatable via an electronic switch 63) and a latch electronic control unit (ECU), also referred to as controller or ECU, shown at 67, that at least partially controls the operation of latch assembly 10. In turn, latch ECU 67 actuates power release motor 30 to cause output shaft 48 to rotate a drive gear 50, shown as a worm gear, by way of example and without limitation, which in turn, via meshed engagement, drives power release gear 52 in a release direction, shown as being counterclockwise, as indicated by arrow 51 in FIG. 3. As power release gear 52 is rotatably driven counterclockwise from its home position to its release position, drive pin 54 drives release link 36 against the bias of biasing release link biasing member 44, whereupon driven pin 56 is engaged by an end of slot 60, such that driven pin 56, and pawl 34 fixed thereto, are driven conjointly to move pawl 34 from its ratchet holding position to its ratchet releasing position. With pawl 34 moved to its ratchet releasing position, ratchet 32 is free to move to its striker releasing position under the bias of ratchet biasing member 40. Power release motor 30 can be alternatively activated as part of a proximity sensor based entry feature (radar based proximity detection for example), for example when a person approaches vehicle 14 with electronic key fob 28 (FIG. 2) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 67 that at least partially controls the operation of latch assembly 10). In turn, if detecting a normal use condition, such as the presence of electronic key fob 28, by way of example and without limitation, latch ECU 67 actuates power release motor 30 to rotate the output shaft 48 and drive gear 50 to release the latch mechanism 16 and shift latch assembly 10 into an unlatched operating state so as to facilitate subsequent opening and presenting of vehicle door 12, as discussed above and in further detail below.

With latch mechanism 16 actuated to the release position, door 12 is able to be moved to the presented position, such that a person can easily grasp an edge of the door 12 or handle 26, as desired, to move the door 12 from the presented position to the fully open position. To facilitate moving door 12 to the presented position, a presenter assembly 62 is provided, including power presenter actuator 31 and a presenter arm 64 configured for movement between a non-deployed position, whereat the presenter arm 64 is configured to be spaced from the striker 18, such that a gap G (FIG. 2A) is provided therebetween, while ratchet 32 is in its striker capture position, and a deployed position, whereat presenter arm 64 is moved into operable engagement with the striker 18, and for example, for direct engagement with the striker 18, while ratchet 32 is in its striker releasing position, to move the closure panel 12, with striker 18 fixed thereto, from the closed position to the presented position. Presenter arm 64, in the non-limiting illustrated embodiment, is configured for pivotal movement, under the influence of a torque force, about a presenter arm axis 64′ (FIG. 2B), wherein pivot arm axis 64′ can be define by a pivot pin (not shown) fixed to housing 29, between the non-deployed position and the deployed position, as discussed further below. Presenter arm 64 may be configured as presenter member, such as curvi-linearly extendable and retractable member as an example, and is configured for engagement with striker 18 through movement of the presenter member within the fishmouth 19.

To facilitate coordinated movement between latch mechanism 16 and presenter assembly 62, power release actuator 30 is configured in operable communication with power presenter actuator 31 via controller 67. In accordance with a preferred aspect, power presenter actuator 31 is configured to be actuated immediately after actuation power release actuator 30, such that power release actuator 30 is configured to move pawl 34 from the ratchet holding position to the ratchet releasing position prior to power presenter actuator 30 moving presenter arm 64 from the non-deployed position to the deployed position. However, it is to be recognized that controller 67 could signal power release actuator 30 in simultaneous relation with power presenter actuator 31, if desired, though, to best avoid unwanted interference between ratchet 32 and striker 18 during initiation of presenting door 12, it is believed optimal to have a slight delay, such as a fraction of a second (milliseconds), prior actuation of power presenter actuator 31 after actuation of power release actuator 30. This way, ratchet 32 will be able to freely move to the striker releasing position during or prior to movement of striker 18 outwardly from striker slot 38 of ratchet 32.

Upon moving door 12 to the presented position, controller 67 can be configured to automatically command (signal) power presenter actuator 31 to move presenter arm 64 from the deployed position back to the non-deployed position, such as within a predetermined time, e.g. 5-10 seconds, or some other readily programmable and selectable timeframe, such as can be easily changed by a ready access menu of options available to an owner of the vehicle, or immediately upon moving the closure door 12 to the presented position, as desired. Further yet, if desired, presenter assembly 62 can be selectively deactivated by the owner of the motor vehicle 14, such as through the menu of options available, if desired. Controller 67 can be configured to actuate power release actuator 30 and power presenter actuator 31 in response to a variety of different types of sensors, such as, by way of example and without limitation, a pawl position sensor 69 arranged to detect when the pawl 34 is in the ratchet holding and ratchet releasing positions, and/or a power release gear sensor 71 arranged to detect the precise position of the power release gear 52, such as when the power release gear 52 is in a home position corresponding to the pawl 34 being in the ratchet holding position and a pawl release position corresponding to the pawl 34 being in the ratchet releasing position.

To greatly increase the force imparted on the striker 18 to ensure reliable movement of door 12 to the presented position, even during situations where increased resistance may be present, such as could result from a buildup of ice and/or snow between the edge of the door 12 and vehicle body 22 or on latch mechanism 16, or upon damage having occurring to door 12 and/or vehicle body 22, a multistage reduction mechanism 68 is provided to apply an increased torque force on presenter arm 64, while also providing a speed reduction. Presenter arm 64 may thus be activated to provide a high output force to act on the striker 18 in a smooth and controlled manner. Reversed operation of the multistage reduction mechanism 68 can also provide for a reset or return of the presenter arm 64 to a non-deployed position from the deployed position. Multistage reduction mechanism 68 operably connects an output shaft, also referred to as output 70, of power presenter actuator 31 to presenter arm 64.

Multistage reduction mechanism 68 includes a plurality of gear reductions GR. The plurality of gear reductions GR includes first gear reduction GR1 configured in meshed engagement with a second gear reduction GR2, and a third gear reduction GR3 configured in meshed engagement with the second gear reduction GR2. The first gear reduction GR1 is provided by an output gear, shown as a worm gear 72, by way of example and without limitation, fixed to the output 70 of power presenter actuator 31, configured in meshed engagement with a first driven gear 74. The second gear reduction GR2 is provided by a first pinion gear 76, fixed to first driven gear 72 for conjoint rotation therewith about a common axis, configured in meshed engagement with a second driven gear, also referred to as intermediate gear 78. The third gear reduction GR3 is provided by a plurality of presenter arm gear teeth 80 configured in meshed engagement with a second pinion gear 82 fixed to second driven gear 78 for conjoint rotation therewith about a common axis. Accordingly, the presenter arm gear teeth 80, shown as extending along an outer periphery of an arcuate portion 84 of presenter arm 64, form a portion of the multistage reduction mechanism 68. The arcuate portion 84 extends away from a straight leg portion 86. Leg portion 86 extends from an attachment end, also referred to as proximal end 88, configured to pivot in oscillatory fashion about axis 64′, to a distal end 90. Leg portion 86 is shown as being generally straight, by way of example and without limitation, with arcuate portion 84 extending laterally from distal end 90 back in a general direction of axis 64′ in overlying, spaced relation with leg portion 86 to a striker engagement end 92. As such, presenter arm 64 is generally C, V or U shaped. Striker engagement end 92 is configured for engagement with striker 18 while presenter arm 64 is moving toward its fully deployed position to move striker 18 outwardly from striker slot 38 while moving door 12 to the presented position.

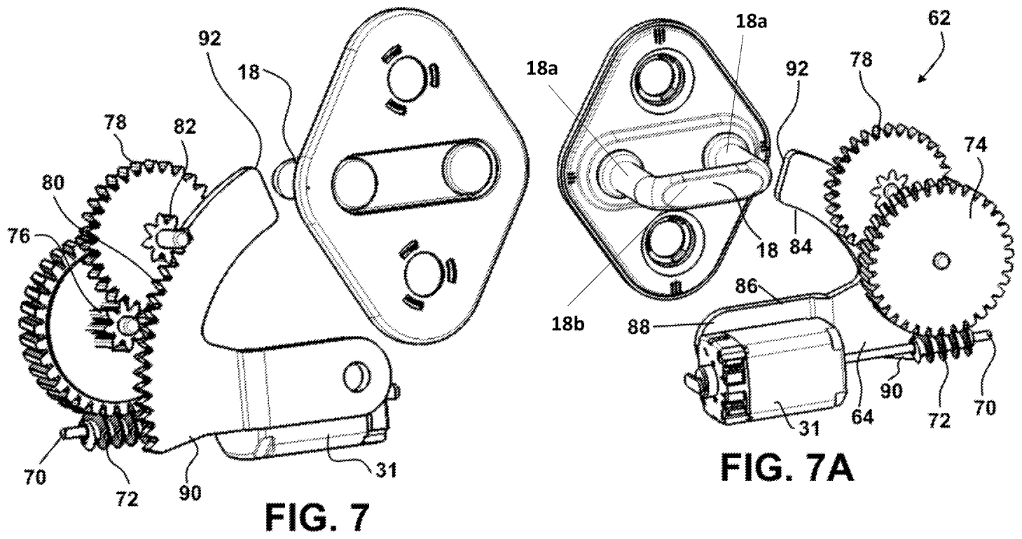

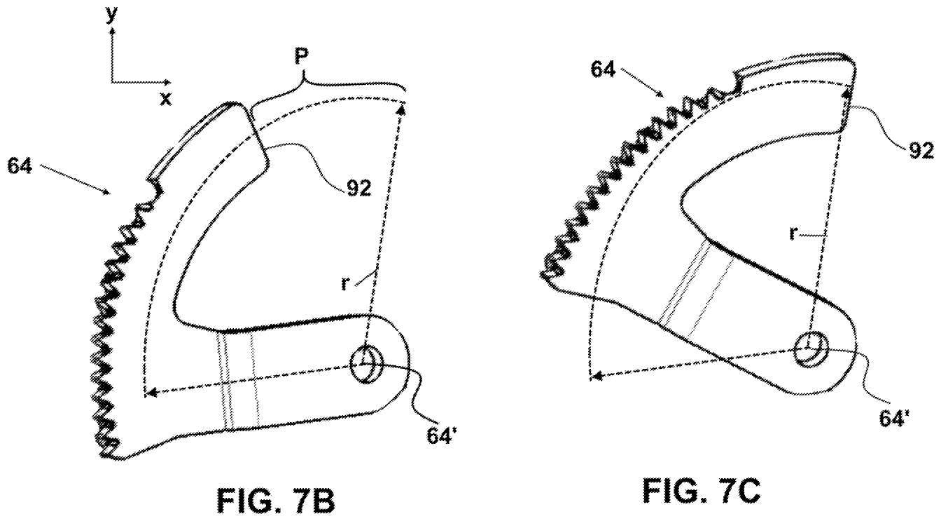

In accordance with another aspect of the disclosure, as shown in FIGS. 7 and 7A, it is to be recognized that the aforementioned presenter assembly 31 can be provided as a standalone apparatus for incorporation with a separate latch assembly including a latch mechanism 16, as discussed above. Accordingly, presenter assembly 31 can be mounted separately from latch assembly or included as an integral component of latch assembly. Presenter assembly 31 is configured as discussed above, and thus, no further discussion is believed necessary.

Now referring to FIG. 7B, and 7C, there is illustrated a non-linear motion of the presenter arm 64 as it moves from a non-deployed position (FIG. 7B) to a deployed position (FIG. 7C). Illustratively the striker engagement end 92 will follow a non-linear path of travel P as the arm 64 moves towards the deployed position. For example, the non-linear path is shown to be an arc centered about the pivot point 64′ by a radius r. Providing for the motion of the striker engagement end 92 along a non-linear path allows a compact arrangement of the presenter arm, which can reduce the packaging size of the latch assembly 10. The arm 64 may extend within the latch 10 having as shown both Y (upwards/downwards dimensions, as well as X dimensions (leftward/rightwards). During the engagement of the striker engagement end 92 with the striker 18, and illustratively with a side extending striker member 18a, sliding interaction of the striker engagement end 92 with the side extending striker member 18a may result. The width of the striker engagement end 92 may be selected to maintain contact with the striker member 18a depending on the final deployment position of the arm 64. Providing engagement of the arm 64 with directly with the striker 18, such as with a part of the striker e.g. striker member 18a ensures the arm 64 contacts a hardened surface of the vehicle body, e.g. a component designed to ensure resistance to high loadings capable to resist the loading of the arm 64. Such a hardened surface, e.g. the striker wire, eliminates the possibility of the arm 64 having to contact sheet metal which may be easily deformed by the high torque output of the arm 64, or which must be additionally reinforced to be able to handle such higher loads at the contact point of the arm 64 to the sheet metal. Furthermore, as the striker 18 is adapted to enter into the latch assembly 10, the arm 64 may begin impart motion on the closure panel before the arm 64 extends outside of the latch 10. In other words, the arm 64 may be closely positioned to the striker 18 when in a non-deployed position and result in more rapid response as compared to known plunger type presenters having to bridge a gap between the plunger end and the vehicle door sheet metal surface. Additionally, the arm 64 may be configured not to extend outside the latch assembly 10, or may extend outside the latch assembly 10 but does not substantially extend outside the latch assembly 10 minimizing the distance an extensible member is visibly projecting from the closure panel, improving the aesthetic “look” as well as reducing or eliminating an obstacle which a user may contact or have clothing become snagged on. It is understood that arm 64 may be further adapted to contact other vehicle components other than a striker 18, and may also be provided as a standalone presenter assembly having the arm 64 move in non-linear, or non-straight path of extension and/or retraction. Due to the striker 18 being directly driven by the arm 64, the striker 18 may also cause the ratchet 32 to rotate towards its open position without having to directly drive the ratchet 32. Additionally, the arm 64 through contacting the striker 18 may be providing in an overlapping arrangement with the ratchet reducing the need to enlarge the latch assembly 10 to accommodate levers for directly moving the ratchet 32 for providing a presenting function as in known devices.

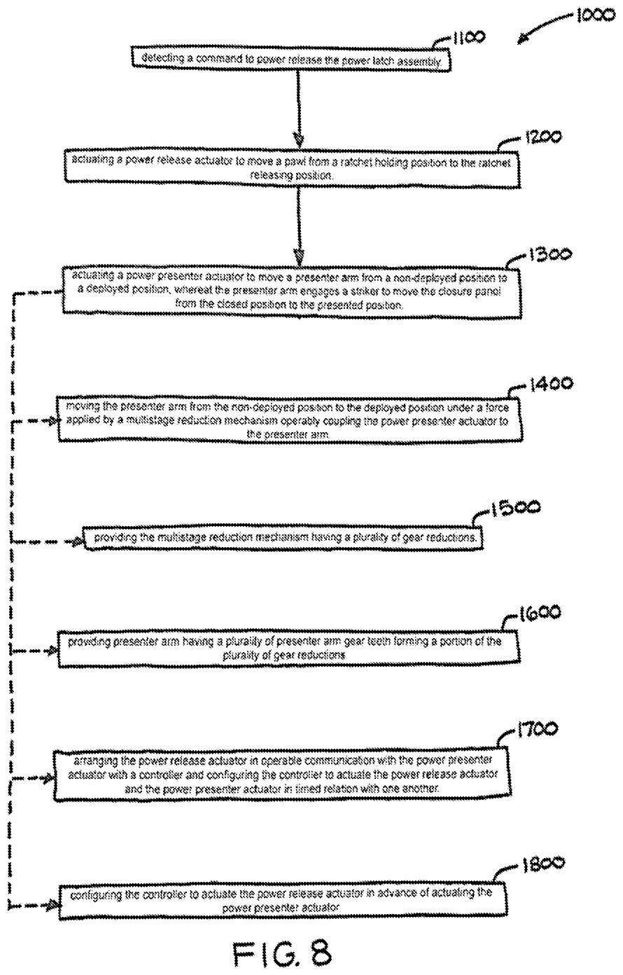

In accordance with another aspect of the disclosure, as shown in FIG. 8, a method 1000 of releasing a power latch assembly 10 and moving a closure panel 12 of a motor vehicle 14 from a closed position to a presented position is provided. The method 1000 includes, a step 1100 of detecting a command signal to power release the power latch assembly 10; a step 1200 of actuating a power release actuator 30 to move a pawl 34 from a ratchet holding position to the ratchet releasing position; and a step 1300 of actuating a power presenter actuator 31 to move a presenter arm 64 from a non-deployed position to a deployed position, whereat the presenter arm 64 engages a striker 18 to move the closure panel 12 from the closed position to the presented position.

In accordance with a further aspect, the method 1000 can further include a step 1400 of moving the presenter arm 64 from the non-deployed position to the deployed position under a force applied by a multistage reduction mechanism 68 operably coupling the power presenter actuator 31 to the presenter arm 64.

In accordance with a further aspect, the method 1000 can further include a step 1500 of providing the multistage reduction mechanism 68 having a plurality of gear reductions GR.

In accordance with a further aspect, the method 1000 can further include a step 1600 of providing presenter arm 64 having a plurality of presenter arm gear teeth 80 forming a portion of the plurality of gear reductions (GR).

In accordance with a further aspect, the method 1000 can further include a step 1700 of arranging the power release actuator 30 in operable communication with the power presenter actuator 31 with a controller 67 and configuring the controller 67 to actuate the power release actuator 30 and the power presenter actuator 31 in timed relation with one another.

In accordance with a further aspect, the method 1000 can further include a step 1800 of configuring the controller 67 to actuate the power release actuator 30 in advance of actuating the power presenter actuator 31.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch and presenter assembly for latching and releasing a closure panel and for moving the closure panel from a closed position to a presented position relative to a motor vehicle body, comprising:
a ratchet configured for movement between a striker capture position, whereat said ratchet captures a striker against release, and a striker release position, whereat said ratchet releases the striker, said ratchet being biased toward the striker release position;
a pawl configured for movement between a ratchet holding position, whereat said pawl maintains said ratchet in said striker capture position, and a ratchet releasing position, whereat said pawl releases said ratchet for movement of said ratchet to the striker release position;
a power release actuator configured to move said pawl from the ratchet holding position to the ratchet releasing position;
a presenter arm configured for movement between a non-deployed position, whereat said presenter arm is configured to be spaced from the striker, and a deployed position, whereat said presenter arm is configured for engagement with the striker to move the closure panel from the closed position to the presented position; and
a power presenter actuator configured to move said presenter arm from the non-deployed position to the deployed position.

2. The power latch and presenter assembly of claim 1, wherein said presenter arm is configured for pivotal movement about a presenter arm axis between the non-deployed position and the deployed position.

3. The power latch and presenter assembly of claim 1, wherein the presenter arm is adapted to follow a non-linear path between the non-deployed position and the deployed position.

4. The power latch and presenter assembly of claim 3, further including a multistage reduction mechanism operably connecting an output of said power presenter actuator to said presenter arm, wherein said multistage reduction mechanism applies a torque force on said presenter arm.

5. The power latch and presenter assembly of claim 4, wherein said multistage reduction mechanism includes a plurality of gear reductions.

6. The power latch and presenter assembly of claim 5, wherein said plurality of gear reductions includes first gear reduction configured in meshed engagement with a second gear reduction, and a third gear reduction configured in meshed engagement with said second gear reduction.

7. The power latch and presenter assembly of claim 6, wherein said presenter arm has presenter arm gear teeth forming a portion of said multistage reduction mechanism.

8. The power latch and presenter assembly of claim 7, wherein said first gear reduction is provided by an output gear of said power presenter actuator configured in meshed engagement with a first driven gear, said second gear reduction is provided by a first pinion gear fixed to said first driven gear for conjoint rotation therewith about a common axis, said first pinion gear being configured in meshed engagement with a second driven gear, and said third gear reduction is provided by said presenter arm gear teeth configured in meshed engagement with a second pinion gear fixed to said second driven gear for conjoint rotation therewith about a common axis.

9. The power latch and presenter assembly of claim 1, wherein said power release actuator is configured in operable communication with said power presenter actuator via a controller.

10. The power latch and presenter assembly of claim 9, wherein said power presenter actuator is configured to be actuated immediately after actuation said power release actuator via receipt of a signal from said controller.

11. The power latch and presenter assembly of claim 10, wherein said power release actuator is configured to move said pawl from the ratchet holding position to the ratchet releasing position prior to said power presenter actuator moving said presenter arm from the non-deployed position to the deployed position.

12. The power latch and presenter assembly of claim 1, wherein said controller commands said power presenter actuator to move said presenter arm from the deployed position back to the non-deployed position within a predetermined time.

13. The power latch and presenter assembly of claim 1, wherein said presenter arm in the deployed position does not extend outside the latch assembly.

14. A method of releasing a power latch assembly and moving a closure panel of a motor vehicle from a closed position to a presented position, comprising:
detecting a command to power release the power latch assembly;
actuating a power release actuator to move a pawl from a ratchet holding position to the ratchet releasing position; and
actuating a power presenter actuator to move a presenter arm from a non-deployed position to a deployed position, whereat the presenter arm engages a striker to move the closure panel from the closed position to the presented position.

15. The method of claim 14, further including moving the presenter arm from the non-deployed position to the deployed position under a force applied by a multistage reduction mechanism operably coupling the power presenter actuator to the presenter arm.

16. The method of claim 14, further including providing the multistage reduction mechanism having a plurality of gear reductions.

17. The method of claim 16, further including providing presenter arm having a plurality of presenter arm gear teeth forming a portion of the plurality of gear reductions.

18. The method of claim 14, further including arranging the power release actuator in operable communication with the power presenter actuator via a controller and configuring the controller to actuate the power release actuator and the power presenter actuator in timed relation with one another.

19. The method of claim 18, further including configuring the controller to actuate the power release actuator in advance of actuating the power presenter actuator.

20. A presenter assembly for moving a closure panel from a closed position to a presented position relative to a motor vehicle body, comprising:
a presenter arm configured for movement between a non-deployed position and a deployed position to move the closure panel from the closed position to the presented position; and
a power presenter actuator configured to move said presenter arm between the non-deployed position to the deployed position;
wherein the presenter arm is configured to move along a non-linear path during movement between the non-deployed position and the deployed position.
